(19) United States
(12) Patent Application Publication
(10) Pub. No.: US 2010/0247281 A1
(43) Pub. Date: Sep. 30, 2010

(54) Double Offset Caster System

(75) Inventor: James Kempf, Wallkill, NY (US)

Correspondence Address: Law Office of Scott C Harris Inc, PO Box 1389, Rancho Santa Fe, CA, 92067, US

(73) Assignee: Production Resource Group L.L.C, New Windsor, NY (US)

(21) Appl. No.: 12/750,048

(22) Filed: Mar. 30, 2010

Related U.S. Application Data
(60) Provisional application No. 61/165,035, filed on Mar. 31, 2009.

(51) Int. Cl. B60B 33/00

(52) U.S. Cl. 414/800; 16/45; 16/47; 16/46

(57) ABSTRACT

A double offset caster system uses two sets of rotatable offsets relative to one another so that the caster can move relative to the load. The offset changes in order to change the relative offset between the caster position and the load.

This application claims priority from application No. 61/165,035, filed Mar. 31, 2009.

### BACKGROUND

Casters are used under loads to faciliate moving a load from one position to another. Heavy loads can be easily moved on the wheels. In commercial applications including stage applications, casters may allow the loads to be moved on the stage.

A conventional caster is a single wheel swivel caster which swivels to allow the load associated with it, e.g. a truck or a box, to be moved in different directions. For example, pushing in one direction causes the wheels to swivel to an orientation parallel with the direction of movement, so that the load can move in that direction.

However, when a user wants to change the direction of movement, for example moving from North to South, the casters often need to turn around. The casters are typically swivel mounted so that they can swivel around. However, when the load on the swivels is very heavy, that load presses against the wheels, resisting their movement. When that happens,

the wheel inertia keeps the point of contact with the ground from moving, especially when the load is heavy. This often causes the load to essentially swivel around this point of contact in order to change directions. This movement is called the “swing circle”. Rather than linearly changing directions, therefore, the load swivels around the swing circle, requiring a curve in order to move in the desired linear direction. Therefore, when placing an item in an area, this requires leaving room for that swing circle.

FIG. 1 shows a prior art scene shift caster, also called triple casters, that addresses some of these problems encountered with swivel casters. This permits heavy trucks to change their rolling direction, even from stationary, without changing the wheel direction. These devices can allow trucks and other loads to enter from any direction and leave from any direction on the stage. The triple wheels also have the other effect that they spread the heavy load over a larger stage area, thereby preventing or minimizing damage to the floor.

It has been noticed, however, that these casters have a large swing circle, and a high distance from the ground e.g. 150 mm off the ground. This great height off the ground can cause viewing problems in a stage environment. The front row seats, for example, might have their views obstructed by this kind of caster.

The low-level heavy-duty caster, designed by Mike Barnett and shown in FIG. 2 addresses the height problem by using metal wheels whose canted edges touch the ground. However, the metal wheels can damage floors. In addition, the machining required for this can be reasonably expensive. Also, this device can require a 10-18 inch circular area for clearance.

### SUMMARY

The present application describes a new low-profile caster that is double offset, allowing swivel of the swivel of one part of the caster without swivel of the other part of the caster.

An embodiment describes a device that allows change of direction with a much smaller swing circle.

### BRIEF DESCRIPTION OF THE DRAWINGS

In the Drawings

FIGS. 1 and 2 show prior art casters;

FIG. 3 shows a low-line caster of the prior art;

FIG. 4 shows a side view of an embodiment of a double offset caster;

FIG. 5 shows a top view of the embodiment;

FIG. 6 shows a front view of the embodiment;

FIG. 7 shows a view of the top plate;

FIG. 8 shows a view of the double offset plate;

FIG. 9 shows a view of the caster plate;

FIG. 10 shows how a prior art casters causes swivel around the tangent point of contact with the ground;

FIG. 11 shows how the caster of the present system can swivel without shifting the load position.

### DETAILED DESCRIPTION

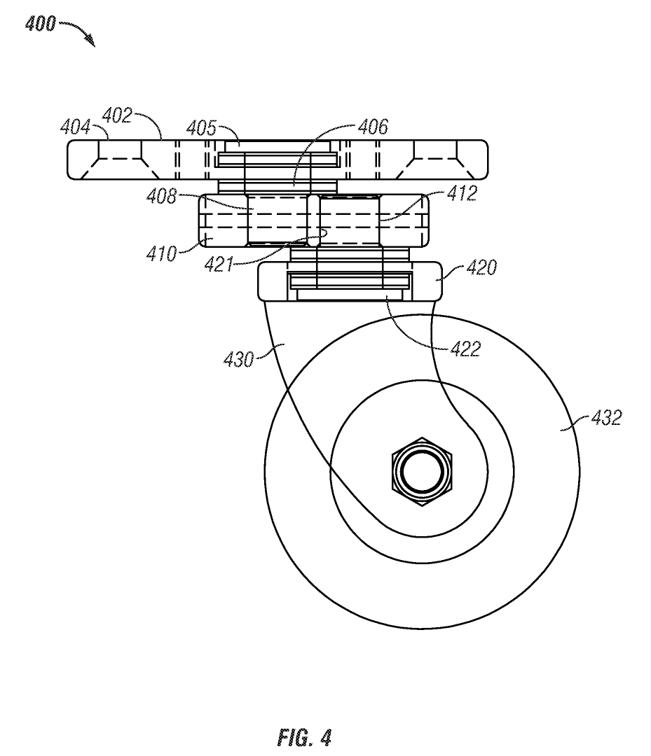

FIG. 4 illustrates an embodiment of a special offset wheel assembly 400 according to an embodiment.

The reason for using a triple swivel caster/double offset caster in the theatre is to avoid the load shifting laterally when the normal swivel caster turns around. This feature may be especially useful when the load is guided in a linear track and cannot shift laterally. Prior art casters required a lateral shift in order to change direction. If the lateral shift was not possible, the caster grinds/drags around the 180 degrees, causing jerky motion and fast wear and possible damage to the floor.

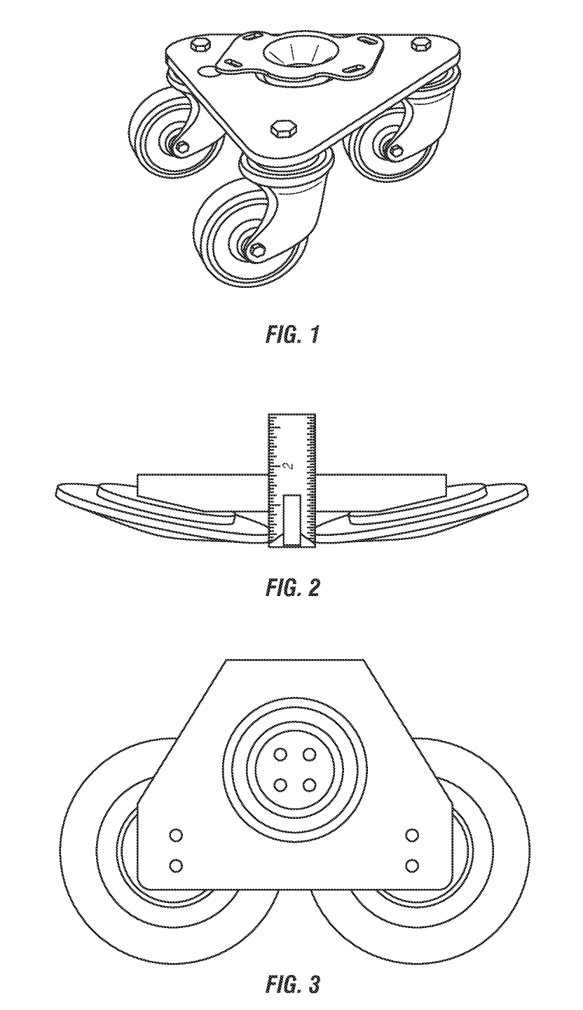

The device described in the embodiments correct for that lateral shift, and also require a much smaller space. For example, the typical triple swivels of the types shown in FIGS. 1-3 may require a 10″ to 18″ circular space for clearance. The item described in the embodiments may fit in a 6.5″ circle, so it goes where no conventional regular triple swivel can fit.

FIG. 4 shows an embodiment where the wheel assembly 400 includes a top plate 402 with fastening holes 404 through which the top plate 402 can be attached to an item, e.g., a load. The top plate 402 may have dimensions between outer walls 450 and 452 of 4 inches by 4 inches. Plate 402 includes a swivel part 405 which can be ball bearings on a pivoting pin, or a roller thrust bearing, or other kind of swivel device.

The bottom portion of the pivot pin 406 is pressfit into an offset plate 410. The offset plate 410 may be of approximately 1½ inches in width, and have two offset pressfit holes 408, 412 whose centers are separated by 0.668 inches. The first pin pressfit part 408 mates with a distal end 406 of the upper pivot pin 406. A second pressfit connection 412 mates with a distal end 421 attached to a lower caster plate 420.

Caster plate 420 includes a lower pivot pin 422, the top part 421 of which is the pressfit into the pressfit connection 421.

The caster plate 420 has caster tabs 430 attached thereto, where each caster tab holds a wheel 432. In this embodiment, the caster tab holds two wheels. However, it should be understood that another embodiment may use a single wheel. The caster plate may have a distance O1 from the left side top 460 to the bottom of the right side 461 of 2.1 inches.

The distance O2, therefore, between the top edge 450 of the top plate 402, and the furthest outer extent 437 of the caster wheel 432, is always less than 6½ inches. Hence, this assembly forms a maximum outer size of approximately 6 inches including the portion of the wheels. Since this does not require lateral loads shift to change direction, this system can operate within that 6½ inch space, and still have a 600 pound load capacity.

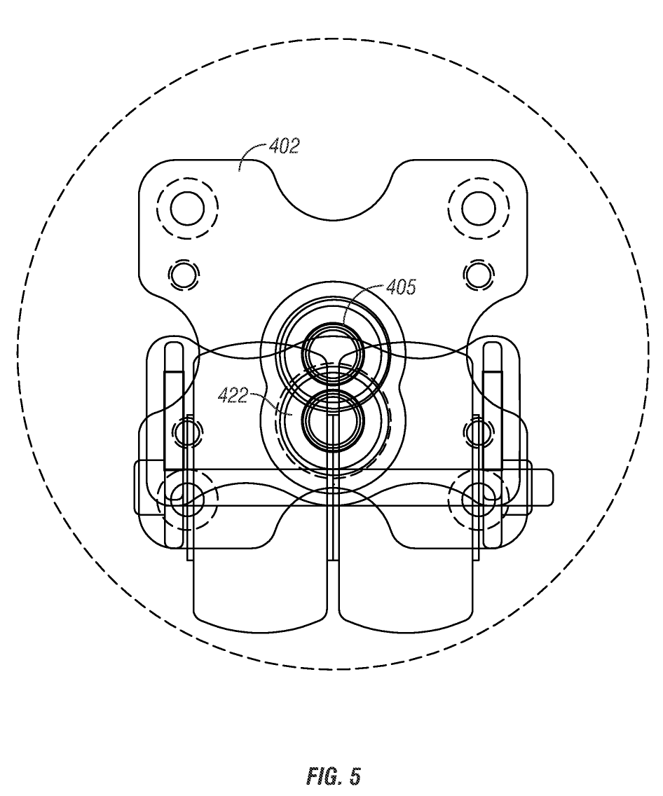

FIG. 5 shows a plan view of the assembly, showing the top plate 402, and the two offset pivot pins 405, 422.

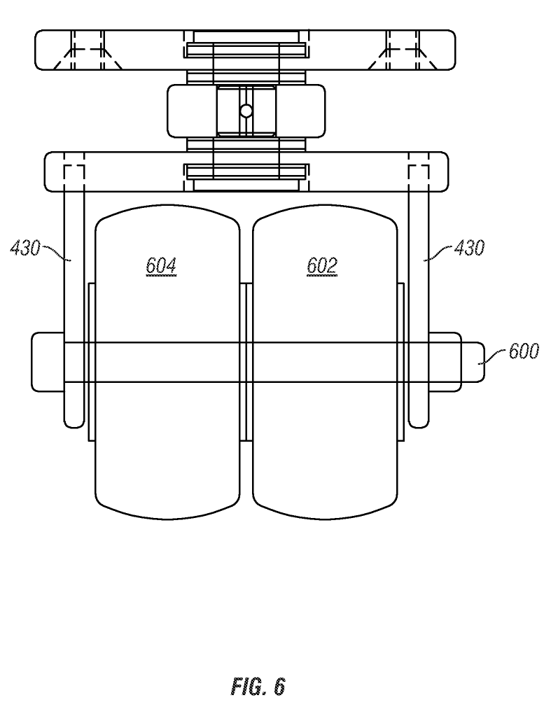

FIG. 6 shows a front view of the wheels 602,604, showing their assembly. A wheel axle 600 may extend through the wheels to hold the wheels rigidly to the caster tabs. The total height from bottom of the wheels to the top of the plate may be for example 4⅝ inches, using 3 inch, 400 pound capacity, wheels

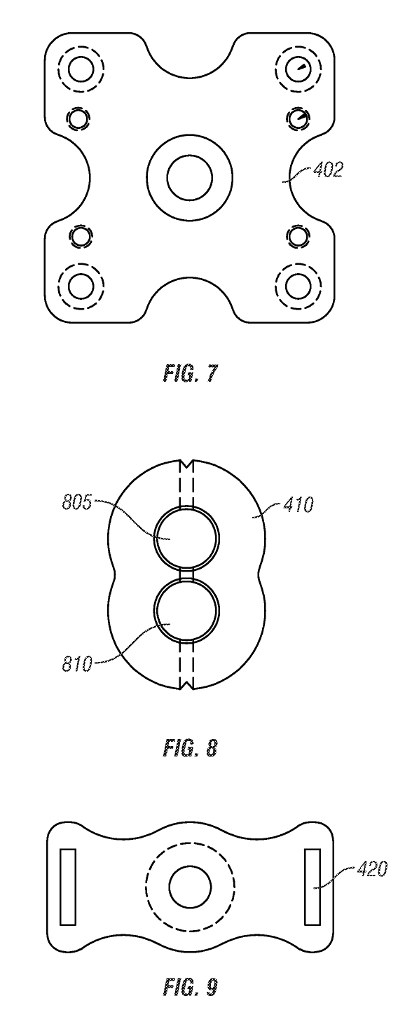

FIG. 7 shows a detailed layout of the top plate. FIG. 8 shows a detailed configuration of the offset plate. The caster plate is shown in FIG. 9.

As shown, one connection 805 on the offset plate is to the center of the top plate. The other connection 810 on the offset plate is to the wheel. The two connections 805, 810 on the offset plate are substantially centered laterally on the offset plate. The connections are equidistant offset, also, on the offset plate. In one embodiment, the wheels can swivel symmetrical relative to the top plate.

The caster wheel 602, 604 are themselves connected through caster flare 430 to the offset plate 420. The wheel is therefore able to swivel in two different dimensions relative to the top plate.

The offset plate can swivel relative the top plate, and also the wheel itself can swivel relative to the offset plate.

Since the offset plate produces an offset relative to the connection point of the wheels, this system can allow changing of rolling direction without supporting the entire weight of the device as shown below.

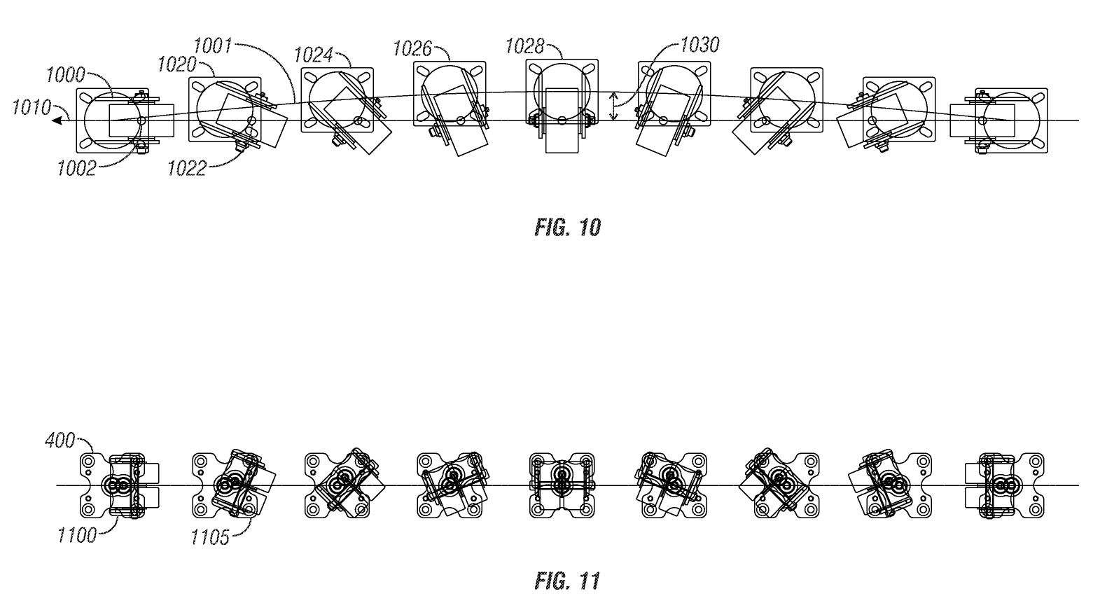

FIG. 10 illustrates how a conventional roller forms a lateral shift of the contact point along the line 1001 as it rotates. In FIG. 10, the roller 1010 is facing parallel to the direction of movement 1010. At points after 1000, the roller is moved relative to the direction of movement. As the roller rotates for example to position 1020, the contact point of the roller to the ground 1022 stays in the same location, and hence must shift relative to the contact point 1002. The dotted line 1001 shows this lateral shift. The load that is on the roller must correspondingly shift by an amount so that the contact point can stay in the same position. The subsequent positions 1024, 1026, 1028 show how the load laterally shifts by an amount 1030 in order to turn around the load completely. As described above, if the load is constrained to a fixed area, this causes that amount of scraping against the ground, thereby causing damage and extra wear. In addition, this prevents linearly changing the direction of moving the load. Rather, changing the direction of the load requires moving the load laterally, as shown in 1001.

FIG. 11 shows how a roller according to the embodiments can shift its position without a lateral movement as it moves without changing the position of the load. The roller 400 is shown in a first position at 1100. As the roller 400 moves to its first moved position 1105, it can be seen how the offset plate shifts positions so that the two pivots 405, 422 actually move rather than the roller moving. Hence, the location of the load stays constant. In the subsequent drawings, it can be seen how the offset plate changes position as the roller moves, thereby enabling movement toward a turnaround of the load without corresponding changing of the roller.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, the embodiment shows a roller which has dual wheels, but as described, this can also operate with a single wheel roller, although more force will be placed on the ground. It can also be used with different kinds of rollers, including triple wheel rollers and the like.

Also, the inventor intends that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A double offset caster system, comprising:
a wheel assembly, which rotates to roll, said wheel assembly having a first connection;
a load connection plate, having a connection to a load, and also having a second connection; and
an offset plate, which has third and fourth connections which are offset from one another, said third connection on said offset plate being connected to said second connection of said load connection plate and a direction between the connection between said second and third connections defining a first axis and said fourth connection of said offset plate connected to said first connection of said wheel assembly, and a direction between the connection between said first and fourth connections defining a second axis, where said first and second axes are substantially parallel to one another but offset laterally relative to one another;
a first rotation device, which allows first rotation between said first connection on said wheel assembly and said fourth connection on said offset plate; and
a second rotation device which allows a second rotation between said second connection on said load connection plate and said third connection on said offset plate.

2. A system as in claim 1, wherein said wheel assembly includes first and second wheels which are maintained substantially parallel to one another.

3. A system as in claim 1, wherein said offset plate includes first and second pressfit connections thereon which are offset from one another.

4. A system as in claim 1, wherein said offset plate includes two connections therein for connection parts.

5. A system as in claim 4, further comprising a first connection part, extending between said load connection plate and said offset plate along said second axis, and a second connection part, extending between said wheel assembly and said offset plate along said first axis.

6. A system as in claim 5, wherein each of said first and second connection parts include pivoting connections at one end, and pressfit connections at the other end.

7. A system as in claim 6, wherein said first connection part has said pivoting connection attached to said load connection plate, and said pressfit connection connected to a pressfit connection in said offset plate, and said second connection part has said pivoting connection connected to said wheel assembly, and has said pressfit connection connected to said offset plate.

8. A system as in claim 6, wherein said pivoting connections include roller thrust bearings.

9. A system as in claim 8, wherein said wheel assembly includes a caster plate, having said connection for said pivoting connection, first and second caster tabs, which are substantially the same shape as one another, and which are spaced from one another, and first and second wheels, held rotatably between said caster tabs.

10. A system as in claim 9, further comprising an axle, extending between said caster tabs, and holding said first and second wheels between said caster tabs.

11. A double offset caster system, comprising:
a wheel assembly, with at least one wheel and a connection part;
a load connection plate, with a connection to a load that will be moved by said caster system;
an offset plate, which has first and second connections which are offset from one another,
said first connection of said offset plate having first surfaces extending in a first direction defining a first axis of said load connection plate,
said second connection of said offset plate having second surfaces extending in a second direction defining a second axis of said wheel assembly,
where said first axis is substantially parallel to and offset from said second axis;
a first rotation device, which allows first rotation on said first axis between said wheel assembly and said offset plate; and
a second rotation device which allows a second rotation on said second axis between said load connection plate and said offset plate.

12. A system as in claim 11, wherein said wheel assembly includes first and second wheels which are maintained substantially parallel to one another.

13. A system as in claim 11, wherein said offset plate includes first and second pressfit connections thereon which are offset from one another.

14. A system as in claim 13, wherein said pressfit connections are laterally in the center of said offset plate in one dimension of said offset plate, and offset from the center of said offset plate in the other dimension of said offset plate.

15. A system as in claim 14, further comprising a first connection part, extending between said wheel assembly and said offset plate along said first axis and a second connection part, extending between said load connection plate and said offset plate along said second axis, and.

16. A system as in claim 15, wherein each of said first and second connection parts include pivoting connections at one end, and pressfit connections at the other end.

17. A system as in claim 16, wherein said second connection part has said pivoting connection attached to said load connection plate, and said pressfit connection connected to a pressfit connection in said offset plate, and said first connection part has said pivoting connection connected to said wheel assembly, and has said pressfit connection connected to said offset plate.

18. A system as in claim 16, wherein said pivoting connections include roller thrust bearings.

19. A system as in claim 18, wherein said wheel assembly includes a caster plate, having said connection for said pivoting connection, first and second caster tabs, which are substantially the same shape as one another, and which are spaced from one another, and first and second wheels, held rotatably between said caster tabs.

20. A system as in claim 19, further comprising an axle, extending between said caster tabs, and holding said first and second wheels between said caster tabs.

21. A method of moving a load on a set of casters, comprising:
moving a load on a caster relative to a floor;
changing a direction of moving said load;
in response to changing said direction, causing a change in the direction between a first part which is connected to the load, and a second part which is connected to the floor, by using an offset plate between said first and second parts, where said offset plate changes direction when the load changes direction.
